(19) United States
(12) Patent Application Publication
(10) Pub. No.: US 2015/0302114 A1
(43) Pub. Date: Oct. 22, 2015

(54) DUPLICATE PATTERN OF ASSEMBLY COMPONENTS IN CAD MODELS

(71) Applicant: Siemens Product Lifecycle Management Software Inc., Plano, TX (US)

(72) Inventors: Arthur S. Patrick, Madison, AL (US); Aditya N. Gurushankar, Madison, AL (US); Srividya Potula, Madison, AL (US); Jeanene Parris, Madison, AL (US)

(73) Assignee: Siemens Product Lifecycle Management Software Inc., Plano, TX (US)

(21) Appl. No.: 14/258,757

(22) Filed: Apr. 22, 2014

(51) Int. Cl. G06F 17/50

(52) U.S. Cl. CPC G06F 17/50

(57) ABSTRACT

Systems and methods for efficient duplication of objects in a CAD model. A method includes receiving a CAD model including a plurality of objects in a model space. The method includes receiving a selection of a first object of the plurality of objects. The method includes receiving a selection of at least one target in the model space. The method includes deriving a transformation matrix corresponding to the model space. The method includes deriving a relative transform according to the transformation matrix and the first object. The method includes deriving a target transformation matrix for each of the targets. The method includes creating, for each target transformation matrix, a duplicate object located in the model space such that the transform between the corresponding target transformation matrix and the duplicate object is equal to the relative transform. The method includes storing the CAD model including the duplicate objects.

### TECHNICAL FIELD

The present disclosure is directed, in general, to computer-aided design, visualization, and manufacturing systems (“CAD systems”), product lifecycle management (“PLM”) systems, and similar systems, that manage data for products and other items (collectively, “Product Data Management” systems or PDM systems).

### BACKGROUND OF THE DISCLOSURE

PDM systems manage PLM and other data, and CAD systems are useful for modeling. Improved systems are desirable.

### SUMMARY OF THE DISCLOSURE

Various disclosed embodiments include systems and methods for efficient duplication of objects in a CAD model. A method includes receiving a CAD model including a plurality of objects in a model space. The method includes receiving a selection of a first object of the plurality of objects. The method includes receiving a selection of at least one target in the model space. The method includes deriving a transformation matrix corresponding to the model space. The method includes deriving a relative transform according to the transformation matrix and the first object. The method includes deriving a target transformation matrix for each of the targets. The method includes creating, for each target transformation matrix, a duplicate object located in the model space such that the transform between the corresponding target transformation matrix and the duplicate object is equal to the relative transform. The method includes storing the CAD model including the duplicate objects.

The foregoing has outlined rather broadly the features and technical advantages of the present disclosure so that those skilled in the art may better understand the detailed description that follows. Additional features and advantages of the disclosure will be described hereinafter that form the subject of the claims. Those skilled in the art will appreciate that they may readily use the conception and the specific embodiment disclosed as a basis for modifying or designing other structures for carrying out the same purposes of the present disclosure. Those skilled in the art will also realize that such equivalent constructions do not depart from the spirit and scope of the disclosure in its broadest form.

Before undertaking the DETAILED DESCRIPTION below, it may be advantageous to set forth definitions of certain words or phrases used throughout this patent document: the terms “include” and “comprise,” as well as derivatives thereof, mean inclusion without limitation; the term “or” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, whether such a device is implemented in hardware, firmware, software or some combination of at least two of the same. It should be noted that the functionality associated with any particular controller may be centralized or distributed, whether locally or remotely. Definitions for certain words and phrases are provided throughout this patent document, and those of ordinary skill in the art will understand that such definitions apply in many, if not most, instances to prior as well as future uses of such defined words and phrases. While some terms may include a wide variety of embodiments, the appended claims may expressly limit these terms to specific embodiments.

### BRIEF DESCRIPTION OF THE DRAWINGS

For a more complete understanding of the present disclosure, and the advantages thereof, reference is now made to the following descriptions taken in conjunction with the accompanying drawings, wherein like numbers designate like objects, and in which:

FIG. 1 illustrates a block diagram of a data processing system in which an embodiment can be implemented;

FIG. 2 illustrates a flowchart of a process in accordance with disclosed embodiments;

FIGS. 3A and 3B illustrate an example of a CAD model in accordance with disclosed embodiments; and

FIGS. 4A and 4B illustrate such a similar component geometry process in accordance with disclosed embodiments.

### DETAILED DESCRIPTION

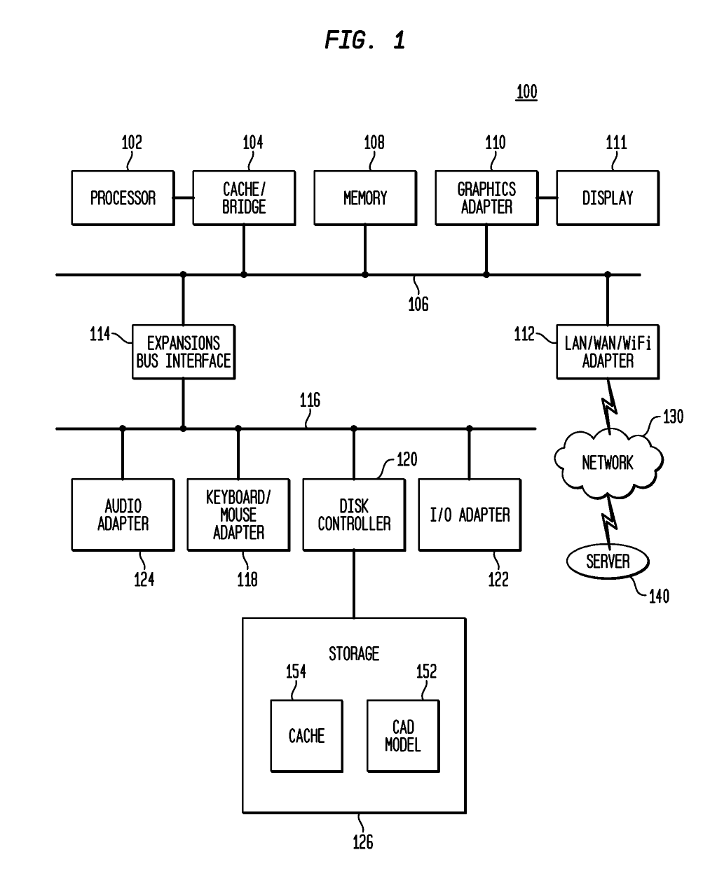

FIGS. 1 through 4B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged device. The numerous innovative teachings of the present application will be described with reference to exemplary non-limiting embodiments.

CAD models, whether two-dimensional (2D) or three-dimensional (3D) often have multiple components that are positioned with respect to one another. It is also common for multiple components of a CAD model to be either copies or mirror-images of one another, placed relative to one another. Disclosed embodiments include systems and methods for adding and positioning components in CAD assemblies where the same or substantially-similar component(s) are placed in a repetitive manor relative to existing components in the assembly.

FIG. 1 depicts a block diagram of a data processing system in which an embodiment can be implemented, for example as a CAD or PDM system particularly configured by software or otherwise to perform the processes as described herein, and in particular as each one of a plurality of interconnected and communicating systems as described herein. The data processing system depicted includes a processor 102 connected to a level two cache/bridge 104, which is connected in turn to a local system bus 106. Local system bus 106 may be, for example, a peripheral component interconnect (PCI) architecture bus. Also connected to local system bus in the depicted example are a main memory 108 and a graphics adapter 110. The graphics adapter 110 may be connected to display 111.

Other peripherals, such as local area network (LAN)/Wide Area Network/Wireless (e.g. WiFi) adapter 112, may also be connected to local system bus 106. Expansion bus interface 114 connects local system bus 106 to input/output (I/O) bus 116. I/O bus 116 is connected to keyboard/mouse adapter 118, disk controller 120, and I/O adapter 122. Disk controller 120 can be connected to a storage 126, which can be any suitable machine usable or machine readable storage medium, including but not limited to nonvolatile, hard-coded type mediums such as read only memories (ROMs) or erasable, electrically programmable read only memories (EEPROMs), magnetic tape storage, and user-recordable type mediums such as floppy disks, hard disk drives and compact disk read only memories (CD-ROMs) or digital versatile disks (DVDs), and other known optical, electrical, or magnetic storage devices. Storage 126 can store any data necessary for operation as described herein, including CAD model 152 and cache 154, discussed in more detail below.

Also connected to I/O bus 116 in the example shown is audio adapter 124, to which speakers (not shown) may be connected for playing sounds. Keyboard/mouse adapter 118 provides a connection for a pointing device (not shown), such as a mouse, trackball, trackpointer, touchscreen, etc.

Those of ordinary skill in the art will appreciate that the hardware depicted in FIG. 1 may vary for particular implementations. For example, other peripheral devices, such as an optical disk drive and the like, also may be used in addition or in place of the hardware depicted. The depicted example is provided for the purpose of explanation only and is not meant to imply architectural limitations with respect to the present disclosure.

A data processing system in accordance with an embodiment of the present disclosure includes an operating system employing a graphical user interface. The operating system permits multiple display windows to be presented in the graphical user interface simultaneously, with each display window providing an interface to a different application or to a different instance of the same application. A cursor in the graphical user interface may be manipulated by a user through the pointing device. The position of the cursor may be changed and/or an event, such as clicking a mouse button, generated to actuate a desired response.

One of various commercial operating systems, such as a version of Microsoft Windows™, a product of Microsoft Corporation located in Redmond, Wash. may be employed if suitably modified. The operating system is modified or created in accordance with the present disclosure as described.

LAN/WAN/Wireless adapter 112 can be connected to a network 130 (not a part of data processing system 100), which can be any public or private data processing system network or combination of networks, as known to those of skill in the art, including the Internet. Data processing system 100 can communicate over network 130 with server system 140, which is also not part of data processing system 100, but can be implemented, for example, as a separate data processing system 100.

Disclosed embodiments include systems and methods that can add and position components to CAD assemblies, including where the same component(s) are placed in a repetitive manner relative to existing components in the assembly.

According to one disclosed process, the system can take, as input, a set of objects to be duplicated, a source object, and one or more target objects. The system can then derive a relative transform between the objects as the basis of the duplication, and position or create duplicate objects (which can include mirrored objects) in the CAD assembly according to the transform(s).

One illustrative example is the case where a bearing is used multiple times in an assembly, and each bearing requires a fastener. In other systems, the user would be required to manually place the fasteners at the location of each occurrence of the bearing in the assembly. This is a time consuming and repetitive process. Disclosed embodiments, in this example, could mark a first fastener as the object to be duplicated, a first bearing (associated with the first fastener) as the source object, and the other bearings as target objects. The system can then define a transform between the first bearing and the other bearings, and based on this transform, create and place the additional fasteners with their respective bearings.

Of course, disclosed embodiments are not limited to the example above and can be used to place any type of graphic object relative to another object as long a relative transform can be derived. Disclosed techniques can be used in 2D or 3D model spaces.

Disclosed embodiments enable placement of new components relative to existing components in the assembly without the use of pre-defined patterns.

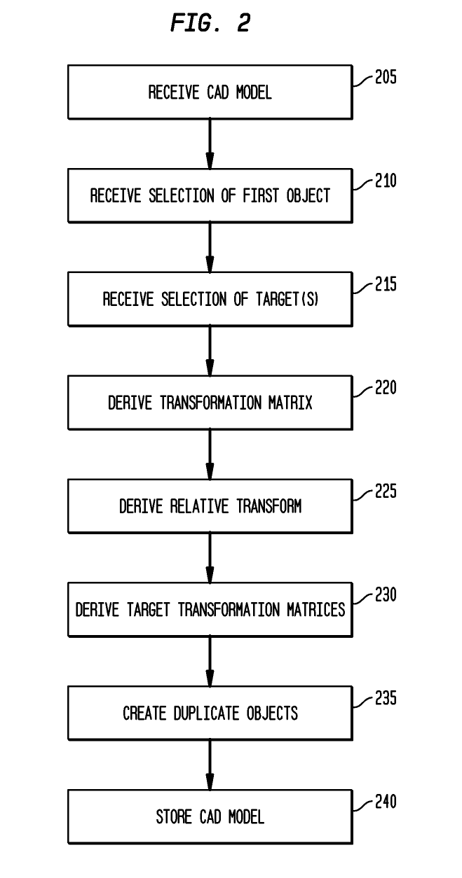

FIG. 2 illustrates a flowchart of a process in accordance with disclosed embodiments, with other figures illustrating examples below. Such a process can be performed, for example, by one or more CAD data processing systems, such as data processing system 100, referred to generically as the “system” below.

The system receives a CAD model including a plurality of objects in a model space (205). The model, objects, and model space can be 2D or 3D in various embodiments.

The system receives a selection of a first object, of the plurality of objects, that is to be duplicated as a duplicate object (210). The selection can be, in specific embodiments, a user input selecting the first object. In other cases, more than one object can be selected, and these together can be processed as the “first object.” “Duplicated” can include duplication with other transformation, such as re-orienting, mirroring, or other similar transformations. The duplicate object is therefore a new object that substantially corresponds in structure to the first object, subject to the transformations described herein. As part of this step, the system can identify a source object in the CAD model that has a geometric or constraint relationship with the first object.

The system receives a selection of at least one target in the model space (215). The target can be a location in the model space, another object proximate to which the duplicate object should be placed, an object that corresponds that itself is a duplicate of an object to which the first object is proximate, or otherwise. The target can be another object that itself is a “duplicate” of the source object, wherein the duplicate objects are intended to have a similar geometric or constraint relationship with the target as the first object has with the source object.

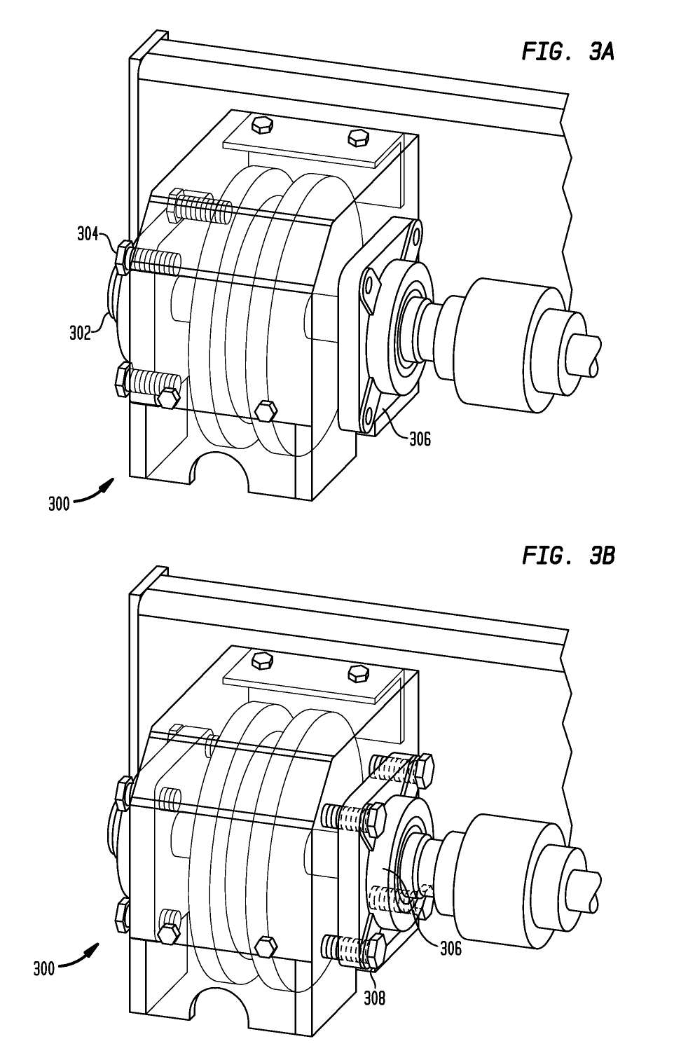

FIGS. 3A and 3B illustrate an example of a CAD model 300 in accordance with disclosed embodiments, which is defined in a model space. In FIG. 3A, bearing 302 is a source object. Fasteners 304 (four bolt-and-washer sets) together are treated as the first object which is to be duplicated. Fasteners 304 are already present in the CAD model 300, and are placed proximate to bearing 302 and are constrained to corresponding mounting holes in bearing 302. In this example, bearing 306 is the target in the model space, and fasteners 304 are intended to be duplicated and placed proximate to bearing 306 according to the processes described herein.

The system derives a transformation matrix corresponding to the model space (220). In some embodiments, deriving the transformation matrix can include deriving a coordinate system from the first object or the source object and the target; in such cases, the target can be user-selected or selected based on a similar component geometry process as described below. The target can be a part occurrence a geometric entity, or otherwise. Deriving a transformation can include receiving the transformation matrix from a user.

A transformation matrix is a matrix, such as a 3×3 matrix, that describes how an object is to be transformed. In a 3×3 example, the upper-left 2×2 sub-matrix controls scaling, rotating, and skewing, while the upper-right 1×2 sub-matrix controls translations. An advantage of using transformation matrices is that cumulative transformations can be described by simply multiplying the matrices that describe each individual transformation. In non-matrix form, a transformation matrix can be represented as x′=Ax+Cy+E and y′=Bx+Dy+F where (x′, y′) is the new coordinate of a point at (x, y). In this equation, E is magnitude of a translation in the x direction and F is magnitude of a translation in the y direction. For scaling, A and D are the scale factors for the x and y directions, respectively. For a pure rotation, A=D=sin(θ) and B=−C=cos(θ) where θ is the angle of the desired rotation. For skewing, C and B control skewing parallel to the x and y axes, respectively.

The system derives a relative transform between the first object or the source object and the transformation matrix (225).

The system derives, for each target, a target transformation matrix (230). In some embodiments, deriving the target transformation matrix can include deriving a coordinate system from the first object or the source object and the target; in such cases, the target can be user-selected or selected based on a similar component geometry process as described below. The target can be a part occurrence, a geometric entity, or otherwise. Deriving a transformation can include receiving the transformation matrix from a user.

The system creates, for each target transformation matrix, a duplicate object located in the model space such that the transform between the target transformation matrix and the duplicate object is equal to the relative transform (235). This step can include addition geometric or constraint relationships between the duplicate object and the target that correspond the relationships between the first object and the source object. In cases where there are multiple first objects to be duplicated, the system can create a duplicate object in the model space in each location such that the transform between the respective target transformation matrix and the corresponding duplicate object is equal to the relative transform.

In the example of FIG. 3B, duplicate object 308 has been placed in CAD model 300 in a position proximate to target 306. In this example, the system also constrains the target—four bolt-and-washer sets—so that each set is properly aligned to the holes in target 306. Note that this example uses only a single component as the target. The bearing could exist at different transforms hundreds of times in the assembly and the process as described herein would duplicate the fasteners to all positions of the bearing a single step.

The system stores the CAD model including the duplicate objects (240).

Similar occurrences—objects in the CAD model to be used as the target—can be found using different techniques and processes, each of which can function as selecting the target in step 215 above and be performed as part of that step. In a “same source component” process, the system will select all occurrences in the CAD model as targets that use the same component (model) as the source component. For example, in the example of FIGS. 3A-3B, the system would select all bearings in the CAD model that are the same as the source bearing. This search/selection action can automatically be invoked by the user in some embodiments.

In a “same component family” process, the system selects all occurrences in the assembly as targets that use the same component family as the source component. An example of this would be a family of parts definition whereby different geometric shapes with common connections define a family.

In as “user defined target” process, the system receives a user selection of the target using normal selection methods for components in the assembly.

In a “similar component geometry” process, the system finds and selects target occurrences and derives a relative transform based on matching geometry. The components may or may not be derived from the same component or CAD Model.

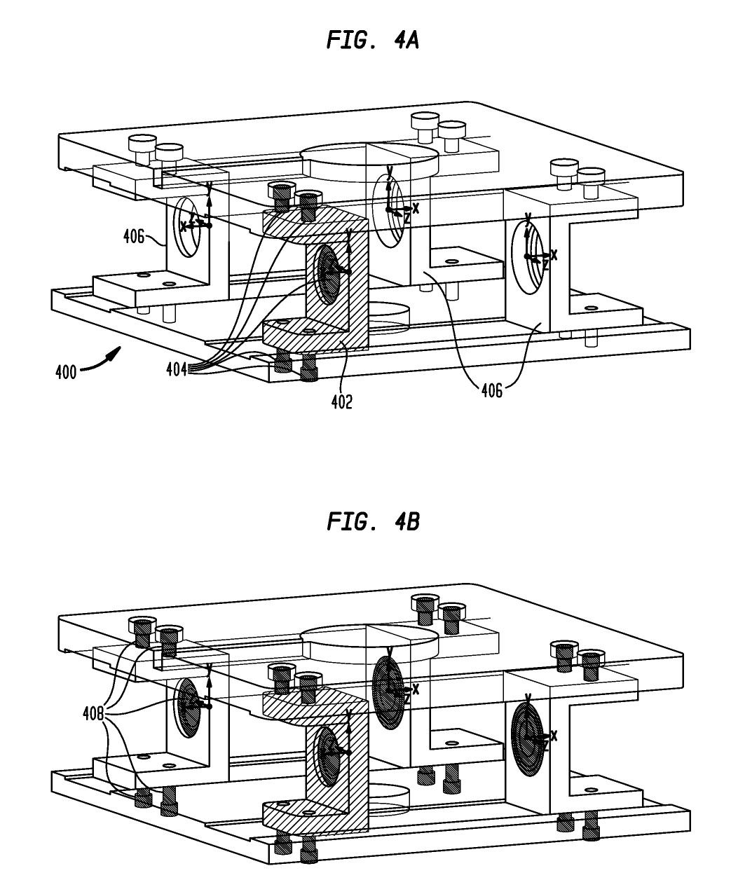

FIGS. 4A and 4B illustrate such a “similar component geometry” process that can be part of step 215 above. In this example, CAD model 400 is shown, including five components 404 (together the “first” object to be duplicated), are placed at a relative location to the source component 402. Using the component 402 as the source, the first objects 404 can be duplicated to the targets 406, which are components that are geometrically similar to the source component 402. In this example, the targets 406 can be selected manually. All that is required is that the areas where the duplicated components 408 are to be placed, as illustrated in FIG. 4B, are positioned at the same location with respect to the respective target 406 within the component model space (note that duplicated components 408 are illustrated in FIG. 4B for each of the targets 406, but reference numbers are not used for all of them to preserve the clarity of illustration).

Of course, those of skill in the art will recognize that, unless specifically indicated or required by the sequence of operations, certain steps in the processes described above may be omitted, performed concurrently or sequentially, or performed in a different order.

Disclosed embodiments provide a technical advantage of faster modeling of CAD models and assemblies by reducing repetitive operations, without relying on predefined patterns or user defined definitions. Disclosed embodiments can exploit the placement location of existing geometry in the design as the basis for which the transforms can be derived.

In many machinery design scenarios, the same set of components is placed relative to a source component that occurs multiple times in the assembly. The ability to duplicate these components to all occurrences of the component as disclosed herein greatly reduces user interaction and design time.

Techniques disclosed herein can also be applied to 2D Drawing creation, piping, and routing applications, including automatic selection and placement based on similar component shapes.

Those skilled in the art will recognize that, for simplicity and clarity, the full structure and operation of all data processing systems suitable for use with the present disclosure is not being depicted or described herein. Instead, only so much of a data processing system as is unique to the present disclosure or necessary for an understanding of the present disclosure is depicted and described. The remainder of the construction and operation of data processing system 100 may conform to any of the various current implementations and practices known in the art.

It is important to note that while the disclosure includes a description in the context of a fully functional system, those skilled in the art will appreciate that at least portions of the mechanism of the present disclosure are capable of being distributed in the form of instructions contained within a machine-usable, computer-usable, or computer-readable medium in any of a variety of forms, and that the present disclosure applies equally regardless of the particular type of instruction or signal bearing medium or storage medium utilized to actually carry out the distribution. Examples of machine usable/readable or computer usable/readable mediums include: nonvolatile, hard-coded type mediums such as read only memories (ROMs) or erasable, electrically programmable read only memories (EEPROMs), and user-recordable type mediums such as floppy disks, hard disk drives and compact disk read only memories (CD-ROMs) or digital versatile disks (DVDs).

Although an exemplary embodiment of the present disclosure has been described in detail, those skilled in the art will understand that various changes, substitutions, variations, and improvements disclosed herein may be made without departing from the spirit and scope of the disclosure in its broadest form.

None of the description in the present application should be read as implying that any particular element, step, or function is an essential element which must be included in the claim scope: the scope of patented subject matter is defined only by the allowed claims. Moreover, none of these claims are intended to invoke paragraph six of 35 USC §112 unless the exact words “means for” are followed by a participle.

What is claimed is:

1. A method for efficient duplication of objects in a CAD model, the method performed by a data processing system and comprising:
receiving a CAD model including a plurality of objects in a model space;
receiving a selection of a first object of the plurality of objects;
receiving a selection of at least one target in the model space;
deriving a transformation matrix corresponding to the model space;
deriving a relative transform according to the transformation matrix and the first object;
deriving a target transformation matrix for each of the targets;
creating, for each target transformation matrix, a duplicate object located in the model space such that the transform between the corresponding target transformation matrix and the duplicate object is equal to the relative transform; and
storing the CAD model including the duplicate objects.

2. The method of claim 1, wherein the duplicate object corresponds in structure to the first object but is mirrored in the model space.

3. The method of claim 1, wherein the first object is multiple objects processed together.

4. The method of claim 1, wherein deriving the transformation matrix includes deriving a coordinate system from the first object and the target.

5. The method of claim 1, wherein deriving the relative transform includes deriving a coordinate system from the first object and the target.

6. The method of claim 1, wherein the selection of at least one target in the model space includes a similar component geometry process.

7. The method of claim 1, wherein the selection of at least one target in the model space includes a same component geometry process.

8. A data processing system comprising:
a processor; and
an accessible memory, the data processing system particularly configured to
receive a CAD model including a plurality of objects in a model space;
receive a selection of a first object of the plurality of objects;
receive a selection of at least one target in the model space;
derive a transformation matrix corresponding to the model space;
derive a relative transform according to the transformation matrix and the first object;
derive a target transformation matrix for each of the targets;
create, for each target transformation matrix, a duplicate object located in the model space such that the transform between the corresponding target transformation matrix and the duplicate object is equal to the relative transform; and
store the CAD model including the duplicate objects.

9. The data processing system of claim 8, wherein the duplicate object corresponds in structure to the first object but is mirrored in the model space.

10. The data processing system of claim 8, wherein the first object is multiple objects processed together.

11. The data processing system of claim 8, wherein deriving the transformation matrix includes deriving a coordinate system from the first object and the target.

12. The data processing system of claim 8, wherein deriving the relative transform includes deriving a coordinate system from the first object and the target.

13. The data processing system of claim 8, wherein the selection of at least one target in the model space includes a similar component geometry process.

14. The data processing system of claim 8, wherein the selection of at least one target in the model space includes a same component geometry process.

15. A non-transitory computer-readable medium encoded with executable instructions that, when executed, cause one or more data processing systems to:
receive a CAD model including a plurality of objects in a model space;
receive a selection of a first object of the plurality of objects;
receive a selection of at least one target in the model space;
derive a transformation matrix corresponding to the model space;
derive a relative transform according to the transformation matrix and the first object;
derive a target transformation matrix for each of the targets;
create, for each target transformation matrix, a duplicate object located in the model space such that the transform between the corresponding target transformation matrix and the duplicate object is equal to the relative transform; and
store the CAD model including the duplicate objects.

16. The computer-readable medium of claim 15, wherein the duplicate object corresponds in structure to the first object but is mirrored in the model space.

17. The computer-readable medium of claim 15, wherein the first object is multiple objects processed together.

18. The computer-readable medium of claim 15, wherein deriving the transformation matrix includes deriving a coordinate system from the first object and the target.

19. The computer-readable medium of claim 15, wherein deriving the relative transform includes deriving a coordinate system from the first object and the target.

20. The computer-readable medium of claim 15, wherein the selection of at least one target in the model space includes a similar component geometry process or a same component geometry process.
